(19) United States
(12) Patent Application Publication
(10) Pub. No.: US 2007/0105732 A1
(43) Pub. Date: May 10, 2007

(54) SOFTENING COMPOSITIONS

(75) Inventor: Veronica BOLARI, Luzzana (Bergamo) (IT)

Correspondence Address: HESLIN ROTHENBERG FARLEY & MESITI PC, 5 COLUMBIA CIRCLE, ALBANY, NY, 12203, US

(73) Assignee: SAGITTA SRL., Luzzana (Bergamo) (IT)

(21) Appl. No.: 11/553,553

(22) Filed: Oct. 27, 2006

(30) Foreign Application Priority Data
Nov. 9, 2005 (IT) TO2005A000787

(51) Int. Cl. C11D 9/44; C11D 3/50

(52) U.S. Cl. 510/101

(57) ABSTRACT

The present invention relates to softening compositions, in particular to softening compositions for the washing cycle in laundry washing operations, including a softening agent and aloe vera.

### CROSS-REFERENCE TO RELATED APPLICATIONS

This application claims priority to Italian Patent Application No. TO2005A000787, filed Nov. 9, 2005, the disclosure of which is incorporated herein by reference in its entirety.

This application contains subject matter which is related to the subject matter of co-owned U.S. patent application Ser. No. ______, by Veronica Bolari, entitled “METHOD FOR TREATING TEXTILES AND ARTICLES OF CLOTHING” (Attorney Docket No. 2177.076 (BUS8288-CF/sr), which is assigned to the same assignee as this application and filed on the same day as this application, and which is hereby incorporated herein by reference in its entirety.

### BACKGROUND OF THE INVENTION

The present invention relates to softening compositions, in particular to softening compositions for the washing cycle in laundry washing operations.

Softeners for the rinsing cycle have long been known and are described in numerous patents and other publications.

The purpose of softening compositions is—in general—that of providing easier ironing, anti-static properties, and more pleasant properties of the fabric to the touch.

### SUMMARY OF THE INVENTION

The present invention has as its object that of providing a softening composition capable of giving to the treated product a particular hand, softness and slipperiness and particular comfort to the user wearing the garment and, in general, of restoring—in the household environment—the garment's “nobilitation”, where by “nobilitation” is meant a treatment performed at the industrial level aimed at improving the characteristics of use and upkeep of fabrics and garments made with chemical fibres in general and cellulose fibres in particular.

According to the present invention, this object is achieved thanks to the solution described specifically in the following claims. The claims form an integral part of the technical instruction provided here in regard to the invention.

In an embodiment at present preferred, the invention concerns a softening composition including aloe vera.

Application of aloe vera during the laundry rinsing phase and thus its penetration into the fibres of the fabric gives the treated laundry a particular hand, softness and slipperiness that improve its characteristics of use. More specifically, once worn the fabric releases a part of the absorbed aloe and gives a feeling of well-being on the skin, such as for example the sensation of a smooth and velvety skin.

The invention will now be described in detail, as a simple example without limiting intent.

### DETAILED DESCRIPTION OF THE INVENTION

In an embodiment at present preferred, the softening composition according to the present invention includes a softening agent, aloe vera, and optionally perfume, such as, for example, essences of amber and/or lavender.

The softening agent in itself does not comprise an innovative aspect of the present invention and may consist of any softening agent currently available on the market. In a particularly preferred embodiment, the softening agent essentially comprises an ester of a fatty acid having the aspect of a liquid dispersion or cream. The softening agent also presents a slightly cation-active character, an acid pH and good solubility in cold water. The softening agent also presents good resistance: it is resistant to pH values in the range from 2.5 to 9.5; it does not go yellow even if subjected to drying up to 120° C.; it does not go rancid.

Aloe vera preferably presents as a water-based silicon emulsion containing aloe Vera; the siloxane component presents aminoalkyl groups and is indexed in Chemical Abstracts with the reference number CAS N. 75718-16-0 15-25% Xi R36. However, it should be understood that in the sphere of the present invention aloe vera may be used in any other form or in combination with any other chemical compound.

The perfumed essences may comprise mixtures of aromatic substances or of natural oils, if preferred in association with aromatic essences combined with methoxypropoxyprepanol.

In a preferred embodiment, the amber essence comprises a mixture of aromatic substances; the lavender essence comprises a mixture of modified natural oils, if preferred in association with aromatic essences in combination with methoxypropoxyprepanol.

The softening composition, in one of its preferred embodiments, comprises the softening agent (for example that marketed under the name RAOMINA ASL/85/1) in a quantity between 50% and 85% by volume, preferably between 65% and 80% by volume, even more preferably between 70% and 76% by volume. Aloe vera (for example that marketed under the name NFARFINISH MS ALOE) is present in a quantity expressed in percentage terms by volume between 10% and 30%, more preferably between 15% and 25%. The aromatic essences (for example those marketed under the names ESSENZA HSZ 154 AMBRA and ESSENZA HS 31 LAVANDA) are generally in the range between 1% and 5% by volume, more preferably around 2-3%.

Naturally, the production details and embodiments may be widely varied with regard to what is described and illustrated without thereby departing from the sphere of protection of the present invention, as defined by the attached claims.

I claim:

1. A laundry softening composition comprising a softening agent comprising aloe vera as a water-based silicon emulsion.

2. The composition according to claim 1, wherein the percentage volume of aloe vera is between 10% and 30% of the total volume.

3. The composition according to claim 2, wherein the percentage volume is between 15% and 25% of the total volume.

4. The composition according to claim 3, wherein the percentage volume is 20% of the total volume.

5. The composition according to claim 1, wherein the softening agent further comprises an ester of a fatty acid.

6. The composition according to claim 1, wherein the percentage volume of the softening agent is between 50% and 85% of the total volume.

7. The composition according to claim 6, wherein the percentage volume is between 65% and 80% of the total volume.

8. The composition according to claim 7, wherein the percentage volume is between 70% and 80% of the total volume.

9. The composition according to claim 1, further comprising at least one perfume.

10. The composition according to claim 9, wherein said at least one perfume is selected from amber essence and lavender essence.

11. The composition according to claim 10, wherein said at least one perfume is amber essence further comprising a mixture of aromatic substances.

12. The composition according to claim 10, wherein said at least one perfume is lavender essence further comprising a mixture of modified natural oils.

13. The composition of claim 12, wherein the mixture of modified natural oils further comprises aromatic essences combined with methoxypropoxyprepanol.

14. The composition according to claim 10, wherein the percentage volume of the amber essence and/or the lavender essence is between 1% and 5% of the total volume.

15. The composition according to claim 14, wherein the percentage volume is between 2% and 3% of the total volume.
